(19) United States
(12) Patent Application Publication
(10) Pub. No.: US 2021/0078299 A1
(43) Pub. Date: Mar. 18, 2021

(54) LAMINATED GLASS HAVING AN OBSCURATION AREA WITH EMBEDDED TRANSPARENT AREAS

(71) Applicant: KURARAY EUROPE GMBH, Hattersheim (DE)

(72) Inventor: Uwe KELLER, Avon (FR)

(73) Assignee: KURARAY EUROPE GMBH, Hattersheim (DE)

(21) Appl. No.: 16/956,877

(22) PCT Filed: Dec. 17, 2018
(86) PCT No.: PCT/EP2018/085249

§ 371 Date: Jun. 22, 2020

(30) Foreign Application Priority Data
Dec. 22, 2017 (EP) 17209906.1

(51) Int. Cl. B32B 17/10; B32B 5/14

(52) U.S. Cl. CPC B32B 17/10348; B32B 17/10036; B32B 17/1066; B32B 2605/00; B32B 5/145; B32B 17/10275; B32B 17/10568; B32B 17/10761

(57) ABSTRACT

A laminated glass contains two sheets of glass; laminated with an adhesive film containing a film B of polyvinyl acetal PB and at least one plasticiser WB; and provided with an obscuration area having at least one transparent area embedded herein, wherein the obscuration area is provided by a film A polyvinyl acetal PA and optionally a plasticiser WA wherein film A is positioned in contact with B and wherein prior to combining the two glass sheets, the amount of plasticiser WA in film A is less than 22% by weight and the amount of plasticiser WB in film B is at least 22% by weight.

### CROSS REFERENCE TO RELATED APPLICATIONS

This application is the U.S. National Phase of PCT Appln. No. PCT/EP2018/085249 filed Dec. 17, 2018, which claims priority to European Application No. EP 17209906.1 filed Dec. 22, 2017, the disclosures of which are incorporated in their entirety by reference herein.

### BACKGROUND OF THE INVENTION

### 1. Field of the Invention

The present invention relates to laminated glass, especially windshields, which are provided with an obscuration area with embedded transparent areas for operating optical devices.

### 2. Description of the Related Art

In most windshields for cars, the inner glass sheet is provided with a non-transparent, mostly black, frame to protect the sealing or the adhesive which mechanically connects the windshield with the chassis from UV radiation. Alternatively, a black obscuration band can be applied to the outer glass sheet in a windshield which can be preferred for higher end cars. A common technique is to silk screen print low melting black glass frit on the glass surface and then sinter this frit at temperatures over 600° C.

Applying of so called “black frit” with a sintering process is an established technology, but it alters the heat absorption properties of the glass part at the position of the obscuration areas, what causes temperature gradients in the glass part over short distances and will thus give rise to strong local deviations from the intended geometry. Resulting bending flaws can worsen the visual appearance of the glazing part for driver and passengers looking through such a glazing part, or may even give rise to local changes of optical refraction power (optical flaw) which are so strong that this leads to failures in the operation of optical sensors positioned behind the windshield. Such optical devices or sensors are usually mounted behind non-transparent obscuration areas to avoid stray light and to cover the devices form being seen form outside of the vehicle. Such obscuration areas for windscreens made from “black frit” provided with cameras as optical sensors are for example disclosed in US20160243796.

Especially for autonomous driving or assisted driving, the demands on the quality of optical devices in cars will increase. In this respect, any optical flaw of the laminated glass will be undesired.

Accordingly, it was an object of the invention to provide windscreens with obscuration areas without producing optical flaws associated with the black frit sintering process.

From a different technical field, it is known to provide thin PVB-films having a low or no plasticizer content with coatings or electrically conductive structures, which can be combined with common plasticized PVB-films to produce functionalized laminated glazing (EP3074221A1).

It was found that thin PVB-films having a low or no plasticizer content can be coated or printed with pigments.

### SUMMARY OF THE INVENTION

The present invention is therefore directed to a laminated glass comprising two sheets of glass, combined by an adhesive film comprising at least one film B containing a polyvinyl acetal PB and at least one plasticiser WB; and provided with an obscuration area (1) having at least one transparent area (2) embedded therein, wherein the obscuration area is provided by a film A containing a polyvinyl acetal PA and optionally at least one plasticiser WA wherein film A is positioned in contact with film B and wherein prior to combining the two glass sheets, the amount of plasticiser WA in film A is less than 22% by weight and the amount of plasticiser WB in film B is at least 22% by weight.

### BRIEF DESCRIPTION OF THE DRAWINGS

FIG. 1 illustrates one embodiment of the invention with an obscuration area having transparent areas embedded within;

FIG. 2 illustrates a windshield in one embodiment of the invention;

FIG. 3 illustrates an embodiment where Film A is larger than the obscuration area;

FIG. 4 illustrates one embodiment of the invention having an obscuration band;

FIGS. 5A/5B illustrate a laminate of the invention having an obscuration band formed in part from Film A.

FIG. 6 illustrates a further embodiment of the invention.

### DETAILED DESCRIPTION OF THE PREFERRED EMBODIMENTS

Hereinafter, the term “prior to lamination” refers to the state of the films A and B prior to having any contact to each other. For example, the term refers to the composition of each film separately formed and separately wound in individual rolls. The term “prior to lamination” refers to the state for the layers or films before combining them either in the lamination process of the laminated glass or prior to building a stack from the layers used for lamination.

The term “obscuration area” refers to any region of the laminate having a light transmission in the visible spectrum of less than 5%. In a variant, the obscuration area may fade out towards transparency. In such variants, at least a part of the obscuration area of the laminate has a light transmission in the visible spectrum of less than 5%.

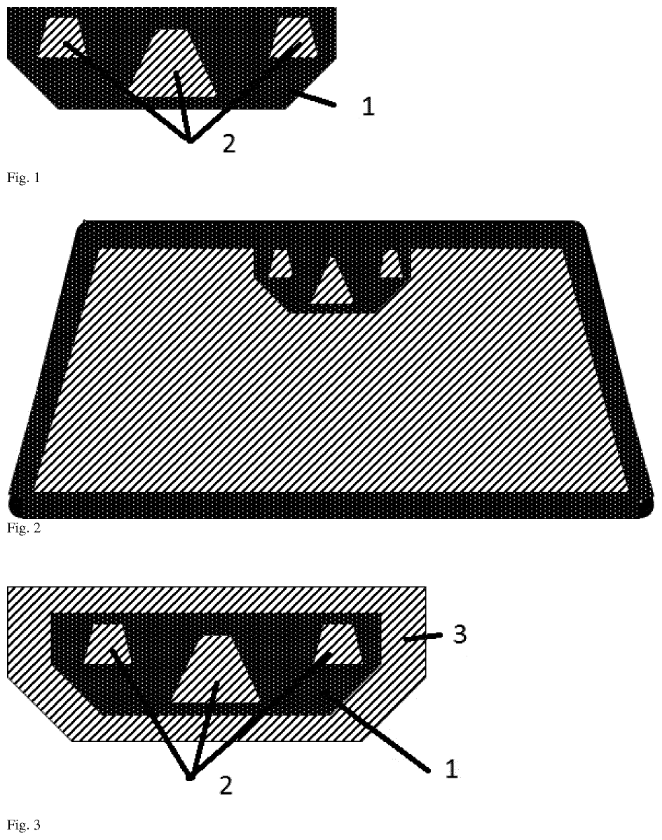

The term “obscuration area having at least one transparent area” refers to one or more regions of the laminate having a reduced light transmission as defined above, with transparent areas embedded therein. For example, FIG. 1 shows an obscuration area (1) and three transparent areas (2). The transparent areas preferably have a light transmission in the visible spectrum not less than the rest of the laminate which is not covered by an obscuration area.

In the laminated glass according to the invention, the transparent areas of the obscuration area may be provided with optical detection devices positioned at or on one surface of a glass sheet. Optical detection devices are digital cameras, range finders, haze meters, rain sensors, target detectors, scanning laser devices (LIDAR) or related devices using electromagnetic radiation from within the UV/VIS and NIR/IR range of the spectrum.

The present invention is also advantageous for laminates comprising thin glass sheets, since sintering enamels on thin glass is even more prone to produce off-spec bended sheets with optical flaws. In a preferred embodiment of the invention, at least one of the glass sheets has a thickness of less than 2.1 mm, such as 1.8 mm, less than 1.8 mm; less than 1.6 mm; less than 1.4 mm; less than 1.0 mm; or less than 0.9 mm.

### Film A

Laminates according to the invention may comprise one or more films A, but at least one thin film A is oriented adjacent to a glass surface of the laminated glass according to the invention. It is also possible to apply a film A to both glass surfaces, such that a laminated glass laminate with a layer sequence glass/film A/film B/film A/glass is provided.

The obscuration area having at least one transparent area may be provided by a printed or coated layer on at least one surface of film A, wherein the transparent areas are not provided with a printed or coated layer.

The printed or coated layer contains an inorganic or organic pigment, which should not dissolve in the polymer matrix and thus resist migration from film A to B.

As pigments, preferably carbon black, iron oxides, polyaniline, perylenes or spinel pigments are used. The pigments may be dispersed in a carrier fluid like water, alcohol or mixtures of alcohol and water. Furthermore, binders like polyvinylalcohol, polyvinylbutyral, polyvinylpyrrolidone, polyacrylates, polyurethanes or poly styrene-acrylate may be present. Such printing compositions are referred to as “printing inks” or simple “inks” hereinafter.

Water-based printing inks are preferred over printing inks based on organic solvents since they do not swell or dissolve the film A and/or lead to film defects. Printing inks based on organic solvents can be used if the coating is thin and/or the drying step is fast such that the solvent does not migrate into the PVB film. It is beneficial to use a low molecular weight PVB as a binder for the printing inks since it ensures good compatibility with the PVB containing films A and B.

The printing inks can be applied via techniques that are commonly known in the printing industry such as offset printing, rotogravure printing, flexography, and screen-printing, followed usually by a drying step.

In order to optimize ink-adhesion to the surface of a film A substrate, corona- or a related treatment can be used for activation of film A's surface prior every individual printing or coating step.

The obscuration area can be completely opaque and/or in part interrupted and/or have a transition area from a completely opaque edge into the non-printed transparent area. Interrupted printing may be achieved in form of dotted patterns. The pigmented band may continuously fade-in from transparent to opaque black or grey (without recurring to easily visible dots).

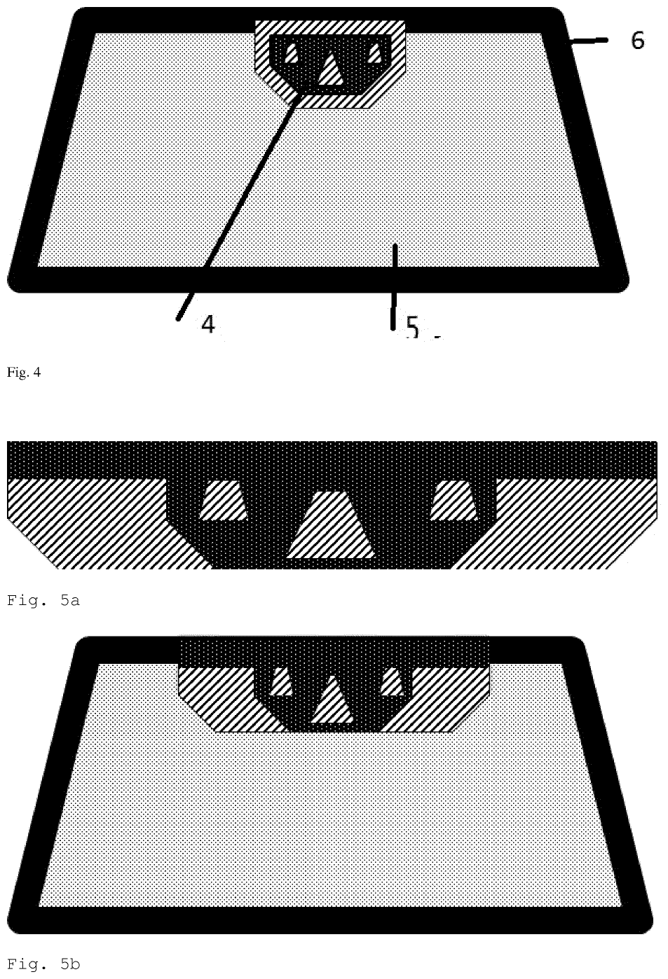

The shape and size of the obscuration area is not of particular importance and may be rectangular or follow the contours of the array field of sensors/cameras present behind the in the laminated glass and/or the entire perimeter of the finished laminated glass. FIGS. 2 and 3 show shapes of the obscuration area by way of example.

In a first variant, film A may have the size of the obscuration area as shown in FIG. 1. In a second variant as in shown FIG. 2 or 6, film A may have the size of film B.

However, film A may have any size between these extreme variants, like slightly larger than the obscuration area as shown in FIGS. 3, 4 and 5. The part of film A which is outside the obscuration area should be as transparent for visible light as possible. At best, the parts of film A outside the obscuration area should be as transparent for visible light as the transparent areas in the obscuration area.

In order to avoid wrinkling and or deformation of film A due to excessive heating in a drying step of the printing or coating process, it is crucial, that film A will not be exposed to temperatures above its glass transition temperature, measurable as Tg by DSC. It is thus preferred, that the temperature of film A during the drying step is kept below Tg of the film by at least 3° C. or at least 5° C. or at least 10° C. or at least 15° C. or most preferred or at least by 20° C.

The dry-film thickness of the printed parts is between 1-50 μm depending on printing technique and required opacity. Usually the dry-film thickness is between 10-30 μm. High enough total dry-film thicknesses can be achieved by overlaying ink-layers through repetition of sequential printing/coating steps.

Preferably, the printed-on or coated-on pigmented layer on film A will be oriented facing film B rather than the glass surface to avoid differences of adhesion between the transparent center and the printed-on edge portion of film A on the glass surface due to components of the pigmented layer.

If a combination of traditional black frit and localized obscuration through film A is desired, any combination and configuration can be applied. E.g. when black frit constitutes a black obscuration band on side 2 of the windshield, the black-printed/-coated film A may be contacting either side 2 or 3 in the windshield. When black frit constitutes a black obscuration band on side 4 of the windshield, the black-printed/-coated film A may be contacting either side 3 or 2 in the windshield. Typically it will be advantageous to position film A in proximity to the black frit layer e.g. in a surface1-surface2/film B/film A/surface3-surface4 with black frit configuration. On the other hand side, 3D effects can be obtained if film A is positioned in non-proximity to a black frit bearing glass surface. For example in a surface1-surface2/film A/film B/surface3-surface4 with black frit configuration or a surface1-surface2 with black frit/film B/film A/surface3-surface4 configuration.

In another variant, the transparent areas of the obscuration area may be obtained by perforating film A prior to the insertion into the glass/film sandwich, such that it can have openings, like passages, holes or slits, in any geometric pattern.

The film A can thus have at least one opening, such that by means of this opening the film B is in direct contact with at least one glass surface. Following adhesive bonding to form the finished laminated glass, the film B with higher plasticiser content in the starting state is adhesively bonded at these points to the glass sheets without interruption. In particular, openings can thus be obtained at points of the laminated glass behind which the function of sensor elements, optics elements and/or antenna elements would otherwise be hindered by an optional heat-shielding or the pigmented layer carried by film A.

Film A in the starting state prior to lamination may have a thickness ratio to film B of less than 0.2.

The thickness of a film A in the starting state prior to lamination is 10-250 μm, preferably 20-160 μm, more preferably 30-120 μm, yet more preferably 40-100 μm, and most preferably 50-80 μm. This range of thickness does not include any additional printing layer/coating layer on the films. In the laminated glass, the thickness of the film can increase by transfer of plasticiser from film B.

Film A is produced separately from film B (for example extruded or solvent cast) and has either no plasticiser at all or a sufficiently small proportion of plasticiser so that subsequent functionalization and processing is not adversely influenced.

Since film A will preferably be in direct contact with one of the inner surface of the laminated glass, it is desirable to control its adhesion to an intermediate level in order to reach satisfactory penetration resistance mandatory for the different glazing positions of a motor vehicle as stipulated in the different safety glass standards like ECE 43R. To this end, film A may contain alkali metal ion and/or earth alkali metal ion to adjust their adhesion level to glass (so called Anti-Adhesion Additives).

As alkali metal ions, potassium or sodium or lithium are preferred. Preferred ranges of concentration of the alkali metal ions are 7-210, preferably 14-140 and more preferably 21-140 ppm in the case of lithium, 23-690, preferably 46-460 and more preferably 69-460 ppm in the case of sodium and 39-1170, preferably 78-780 ppm and more preferably 117-780 in the case of potassium. It is furthermore preferred to add the alkali metal ions in form of salts of carboxylic acids having 1 to 10 carbon atoms. Especially preferred is potassium acetate as an adhesion control agent.

The total amount of alkali metal salts may be as low as 0.005% by weight based on the weight of film A. Preferred ranges of alkali metal salt are 0.01%-0.1%; 0.02-0.08%; and 0.03-0.06%, each weight % based on the weight of film A.

Film A used in the laminates of the invention may additionally comprise alkaline earth ions, but since their effect on adhesion is limited, only small amounts as compared to the alkali ion should be used. In a first embodiment of the invention, film A comprises 0 to 20 ppm alkaline earth ions, preferably 0 to 5 ppm.

However, it is known that alkaline earth ions have a balancing effect of adhesion when a plasticized PVB film faces two glass sheets with different surface chemistry. Accordingly, in a second embodiment of the invention, film A comprises 5-20 ppm alkaline earth ions. The alkaline earth ions can be added in form salts of carboxylic acids having 1 to 10 carbon atoms. Especially preferred is magnesium acetate as a secondary adhesion control agent. In this embodiment, the ratio of alkali ions to alkaline earth ions in ppm in film A is preferably at least 1, especially higher than 5 and more preferably higher than 10.

As an alternative to the amount of alkali and earth alkali ions, the alkaline titer of film A and B may be used to characterize the amount of anti-adhesion agents (i.e. alkali and earth alkali salts) in the films. The alkaline titer of film A may be higher than 10, higher than 20, higher than 40, higher than 50, higher than 80, higher than 90 and preferably higher than 100, in each case with a maximum value of 500. In contrast to film A, the alkaline titer of film B is preferred to be lower, and more particularly, the difference between alkaline titer (film A) -alkaline titer (film B) is more than 2, 6 and preferably more than 10 AT units.

In order to avoid haze, the amount of chloride ions and/or nitrate ions and/or sulphate ions in film A may be reduced.

The chloride content of the film A can thus be less than 150 ppm, preferably less than 100 ppm, and in particular less than 50 ppm. In the ideal case, the chloride content of the film A is less than 10 ppm or even 0 ppm.

The nitrate content of film A optionally may be less than 150 ppm, preferably less than 100 ppm, and in particular less than 50 ppm. In the ideal case, the nitrate content of film A is less than 10 ppm or even 0 ppm.

Again optionally, the sulphate content of film A may be less than 150 ppm, preferably less than 100 ppm, and in particular less than 50 ppm. In the ideal case, the sulphate content of the film A is less than 10 ppm or even 0 ppm.

### Film B

Film B may be any plasticized PVB-film known in the art. The films A and B may contain, in the starting state prior to lamination and/or in a stack prepared for lamination between glass sheets, a single plasticiser as well as mixtures of plasticisers both of different and identical composition. The term “different composition” refers to both the type of plasticiser and proportion thereof in the mixture. Film A and film B after lamination, i.e. in the finished laminated glass, preferably have the same plasticisers WA and WB. In a preferred variant, film A in its starting state, however, does not contain any plasticiser and after lamination contains plasticiser WB in equilibrium amount.

Plasticiser-containing films B used in accordance with the invention contain, in the starting state prior to lamination, at least 22% by weight, such as 22.0-45.0% by weight, preferably 25.0-32.0% by weight, and in particular 26.0-30.0% by weight of plasticiser.

Films A used in accordance with the invention may contain, in the starting state prior to lamination, less than 22% by weight (such as 21.9% by weight), less than 18% by weight, less than 16% by weight, less than 12% by weight, less than 8% by weight, less than 4% by weight, less than 2% by weight, less than 1% by weight, or even no plasticiser (0.0% by weight). In a preferred embodiment of the invention, films A with a low plasticiser content preferably contain 0.0-8% by weight of plasticiser, most preferably 0-4 wt. %.

The films A or B preferably contain polyvinyl acetals having a proportion of polyvinyl acetate groups, either identically or differently, of 0.1 to 20 mol %, preferably 0.5 to 3 mol %, or 5 to 8 mol %.

The thickness of film B in the starting state is 450-2500 μm, preferably 600-1000 μm, more preferably 700-900 μm. A plurality of films B may be used in the invention, either being stacked on each other or separated by films A.

If films B are stretched prior to production of the sandwich and/or additionally are adapted to the shape of a screen (for example a windscreen) in a curved manner, the specified thicknesses at the moment of lamination may reduce once more by up to 20%.

### Polyvinyl Acetal

The films A and B used in accordance with the invention contain polyvinyl acetals, which are produced by acetalisation of polyvinyl alcohol or ethylene vinyl alcohol copolymer.

The films can contain polyvinyl acetals, each having a different polyvinyl alcohol content, degree of acetalisation, residual acetate content, ethylene proportion, molecular weight and/or different chain lengths of the aldehyde of the acetal groups.

In particular, the aldehydes or keto compounds used for the production of the polyvinyl acetals can be linear or branched (that is to say of the “n” or “iso” type) containing 2 to 10 carbon atoms, which leads to corresponding linear or branched acetal groups. The polyvinyl acetals are referred to accordingly as “polyvinyl (iso)acetals” or “polyvinyl (n)acetals”.

The polyvinylacetals used in accordance with the invention result in particular from the reaction of at least one polyvinyl alcohol with one or more aliphatic unbranched keto-compounds containing 2 to 10 carbon atoms. To this end, n-butyraldehyde is preferably used.

The polyvinyl alcohols or ethylene vinyl alcohol copolymers used to produce the polyvinyl acetals in the films A or B may be identical or different, pure or a mixture of polyvinyl alcohols or ethylene vinyl alcohol copolymers with different degree of polymerisation or degree of hydrolysis.

The polyvinyl acetate content of the polyvinyl acetals in the films A or B can be set by use of a polyvinyl alcohol or ethylene vinyl alcohol copolymer saponified to an appropriate degree. The polarity of the polyvinyl acetal is influenced by the polyvinyl acetate content, whereby the plasticiser compatibility and the mechanical strength of the respective layer also change. It is also possible to carry out the acetalisation of the polyvinyl alcohols or ethylene vinyl alcohol copolymers with a mixture of a number of aldehydes or keto compounds.

The films A or B preferably contain polyvinyl acetals having a proportion of polyvinyl acetate groups, either identically or differently, of 0.1 to 20 mol %, preferably 0.5 to 3 mol %, or 5 to 8 mol %.

The polyvinyl alcohol content of the polyvinyl acetal PA used in film A may be between 6-26% by weight, 8-24% by weight, 10-22% by weight, 12-21% by weight, 14-20% by weight, 16-19% by weight, and preferably between 16 and 21% by weight or 10-16% by weight.

Independent of film A, the polyvinyl alcohol content of the polyvinyl acetals PB used in film B may be between 14-26% by weight, 16-24% by weight, 17-23% by weight and preferably between 18 and 21% by weight.

In a preferred embodiment of the invention, film A comprises a polyvinyl acetal PA with a proportion of vinyl alcohol groups from 6 to 26% by weight and the film B comprises a polyvinyl acetal B with a proportion of vinyl alcohol groups from 14 to 26% by weight.

The films A or B preferably contain non-crosslinked polyvinyl acetal. The use of cross-linked polyvinyl acetals is also possible. Methods for cross-linking polyvinyl acetals are described, for example, in EP 1527107 B1 and WO 2004/063231 A1 (thermal self-cross-linking of polyvinyl acetals containing carboxyl groups), EP 1606325 A1 (polyvinyl acetals cross-linked with polyaldehydes) and WO 03/020776 A1 (polyvinyl acetal cross-linked with glyoxylic acid).

### Plasticizer

Films A and/or B used in accordance with the invention may contain, as plasticiser, one or more compounds selected from the following groups:
esters of polyvalent aliphatic or aromatic acids, for example dialkyl adipates, such as dihexyl adipate, dioctyl adipate, hexyl cyclohexyl adipate, mixtures of heptyl adipates and nonyl adipates, diisononyl adipate, heptyl nonyl adipate, and esters of adipic acid with cycloaliphatic ester alcohols or ester alcohols containing ether compounds, dialkyl sebacates, such as dibutyl sebacate, and also esters of sebacic acid with cycloaliphatic ester alcohols or ester alcohols containing ether compounds, esters of phthalic acid, such as butyl benzyl phthalate or bis-2-butoxyethyl phthalate.
esters or ethers of polyvalent aliphatic or aromatic alcohols or oligo ether glycols with one or more unbranched or branched aliphatic or aromatic substituents, for example esters of glycerol, diglycols, triglycols or tetraglycols with linear or branched aliphatic or cycloaliphatic carboxylic acids; Examples of the latter group include diethylene glycol-bis-(2-ethyl hexanoate), triethylene glycol-bis-(2-ethyl hexanoate), triethylene glycol-bis-(2-ethyl butanoate), tetraethylene glycol-bis-n-heptanoate, triethylene glycol-bis-n-heptanoate, triethylene glycol-bis-n-hexanoate, tetraethylene glycol dimethyl ether and/or dipropylene glycol benzoate
phosphates with aliphatic or aromatic ester alcohols, such as tris(2-ethylhexyl)phosphate (TOF), triethyl phosphate, diphenyl-2-ethylhexyl phosphate, and/or tricresyl phosphate
esters of citric acid, succinic acid and/or fumaric acid.

By definition, plasticisers are organic liquids having a high boiling point. For this reason, further types of organic liquids having a boiling point above 120 ° C. can also be used as plasticisers.

Films A in the variants in which a plasticiser WA is present in film A in the starting state, and also films B, most preferably contain 1,2-cyclohexane dicarboxylic acid diisononyl ester (DINCH) or triethylene glycol-bis-2-ethyl hexanoate (3GO or 3G8) as plasticiser.

Film B may consist of at least two sub-films B′ and B″, which have a different plasticiser content.

In addition, films A and B may contain further additives, such as residual quantities of water, UV absorber, antioxidants, adhesion regulators, optical brighteners or fluorescent additives, stabilisers, colorants, processing aids, inorganic or organic nanoparticles, pyrogenic silicic acid and/or surface active substances.

In particular, film B may comprise 0.001 to 0.1% by weight of alkaline metal salts and/or alkaline earth salts of carboxylic acids as adhesion control agents. It is preferred that film B contains magnesium ions in an amount of at least 10 ppm, preferably 20 ppm, and most preferably 30 ppm.

### Lamination Process

The present invention also relates to a method for producing the described glass laminates, in which the film A is positioned on a glass sheet, then covered by at least one film B, and a second glass sheet is then applied.

Alternatively, it is possible for film B to be positioned on a glass sheet, then to be covered by at least one film A, and for a second glass sheet to be applied.

The present invention relates furthermore to a method for producing a laminated glass wherein a stack comprising at least one film A and at least one film B is provided, the stack is positioned on a first glass sheet and a second glass sheet is then applied.

It is possible in accordance with the invention to first melt the film A onto a glass sheet over the entire area or locally by increased temperature and to then cover this with the film B. Alternatively, films A and B can be positioned jointly between two glass sheets and melted at increased temperature.

The lamination step for producing a laminated glass is preferably carried out such that films A and B are positioned between two glass sheets and the layered body thus prepared is pressed under increased or reduced pressure and increased temperature to form a laminate.

To laminate the layered body, the methods with which a person skilled in the art is familiar can be used, with and without prior production of a pre-laminate.

So called “autoclave processes” are carried out at an increased pressure from approximately 10 to 15 bar and temperatures from 100 to 150° C. during approximately 2 hours. Vacuum bag or vacuum ring methods, for example according to EP 1 235 683 B1, function at approximately 200 mbar and 130 to 145° C.

Vacuum laminators may also be used. These consist of a chamber that can be heated and evacuated, in which laminated glazings can be laminated within 30-60 minutes. Reduced pressures from 0.01 to 300 mbar and temperatures from 100 to 200° C., in particular 130-160° C., have proven their worth in practice.

In the simplest case, in order to produce the laminated glass laminates, film A or B is positioned on a glass sheet, and the further film B or A is positioned synchronously or subsequently. The second glass sheet is then applied and a glass film laminate is produced. Excessive air can then be removed with the aid of any pre-lamination method known to a person skilled in the art. Here, the layers are also already firstly lightly adhesively bonded to one another and to the glass.

The glass film laminate may then be subjected to an autoclave process. Film A is preferably positioned on the first glass sheet and covered by the thicker film B before the second glass sheet is applied. The method can be carried out in many conceivable and, in principle, practicable variants. For example, film A is easily removed from a roll of an appropriate width, whereas film B has been tailor-cut beforehand to the size of the laminated glass to be produced. This is advantageous in particular in the case of windscreens and other automotive glazing parts. In this case, it is particularly advantageous to additionally still stretch the thicker film B before it is tailor cut. This enables a more economical use of film, or, for the case in which film B has a colour tint, allows the adaptation of the curvature thereof to the upper sheet edge.

In the automotive field, in particular for the production of windscreens, films A and/or B may be provided with a coloured region like an ink ribbon in the upper region of the films. To this end, either the upper part of film B can be co-extruded with a suitably coloured polymer melt.

In accordance with the invention, films B may therefore have a colour tint, which in particular has already been adapted in a prior process step to the geometry of a windscreen by the above described shaping process.

It is also possible for the films B to have a wedge-shaped thickness profile. The laminated glass laminate according to the invention obtains a wedge-shaped thickness profile even with plane-parallel thickness profile of the film A and can be used in motor vehicle windscreens for HUD displays.

Furthermore, film B may comprise at least two layers wherein the amount of plasticizer WB in the layers differs by least 2% by weight. For sound-damping purposes, film B comprises 3 layers of which the core layer is softer due to higher plasticizer content.

### Laminated Glass

Besides the obscuration area, the laminated glass according to the invention may be provided at the edges of at least one glass sheet are provided with an obscuration band (6). Such band is for example shown in FIG. 2, 4, 5, or 6.

The obscuration band (6) may be provided at least in part by a black frit coating on at least one surface of at least one glass sheet, as long as the black frit does not create excessively strong optical flaws at the transparent areas of the obscuration area.

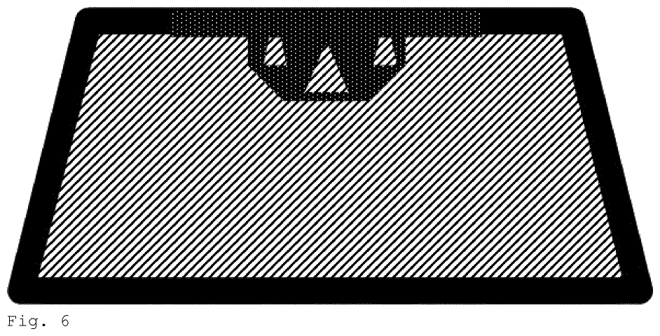

In another embodiment, the obscuration band is provided at least in part by film A as shown in FIG. 5a/b. To this end, film A needs to be provided with a printing/coating at the edges similar or identical to the obscuration area and have substantially the same size and shape as the glass sheets and/or film B.

FIGS. 2, 4, 5 and 6 show these embodiments with the obscuration band and obscuration area as separate or overlapping entities.

In the simplest case, film B is a commercially available PVB film with or without ink ribbon and with or without a wedge-like thickness profile. Films B with nanoparticles dispersed therein for IR protection can also be used as coloured films. Of course, a film B may also be a film having an acoustic function, such that soundproofing properties that are further improved are obtained by combination with a film A. Of course, a film B may already also combine a number of the mentioned functions.

The thin films A are generally produced by extrusion with use of a cast-film line or in the form of a blown film. Here, a surface roughness may also be produced by controlled melt fracture or with the cast-film method additionally by use of a structured chill roll and/or structure back roll. Alternatively, solvent-cast method can be used for producing film A prior to functionalization and use in the described penetration resistant glass laminates. Films used in accordance with the invention preferably have a one-sided surface structure with a roughness Rz from 0 to 25 μm, more preferably Rz from 1 to 20 μm, still more preferably an Rz from 3 to 15 μm, and in particular, an Rz from 4 to 12 μm. It is particularly preferable if the side of film A coming into contact with the glass sheet has a surface roughness Rz of no more than 20% of its thickness.

### Use of the Laminate

The laminated glass according to invention may be used for windscreens, back-lights and side glazing for cars, busses, trucks, ships or airplanes.

1.-14. (canceled)

15. A laminated glass comprising two sheets of glass laminated to each other by an adhesive film comprising at least one film B containing a polyvinyl acetal PB and at least one plasticiser WB in an amount of ≥22 wt. % based on the weight of film B; the laminated glass having an obscuration area with at least one transparent area embedded therein, wherein the obscuration area is provided by a film A containing a polyvinyl acetal PA and optionally at least one plasticiser WA in an amount less than 22 wt. % based on the weight of the film A, wherein film A is positioned in contact with film B, and wherein the amounts of plasticiser WA in film A and the amount of plasticiser WB in film B are the amounts present in the respective films prior to combining the two glass sheets.

16. The laminated glass of claim 15, wherein the obscuration area having at least one transparent area is provided by a printed or coated layer on at least one surface of a film A, and wherein the transparent areas are not provided with a printed or coaled layer.

17. The laminated glass of claim 16, wherein the printed or coated layer is provided by pigments or dyes selected from the group consisting of carbon black, iron oxide, polyaniline, perylenes, spinel pigments, and mixtures thereof.

18. The laminated glass of claim 15, wherein film A is of the size of the obscuration area.

19. The laminated glass of claim 15, wherein film A has the size as film B.

20. The laminated glass of claim 15, wherein the edges of at least one glass sheet are at least in part provided with an obscuration band.

21. The laminated glass of claim 20, wherein the obscuration band comprises at least in part, of a black frit coating on at least one surface of at least one glass sheet.

22. The laminated glass of claim 20, wherein the obscuration band is provided at least in part by film A.

23. The laminated glass of claim 15, wherein the thickness ratio of film A to film B is Less than 0.2.

24. The laminated glass of claim 15, wherein film B comprises at least two layers wherein the amount of plasticizer WB in the layers differs by least 2% by weight.

25. The laminated glass of claim 15, wherein film B has a wedge-shaped thickness profile.

26. The laminated glass of claim 15, wherein at least one transparent area of the obscuration area is provided with one or more optical detection devices positioned at or on one surface of a glass sheet.

27. The laminated glass of claim 26, wherein an optical detection device is a digital camera, range finder, haze meter, rain sensor, target detector, or scanning laser device (LIDAR).

28. A windscreen, back-light, or side glazing for a car, bus, truck, ship or airplane, comprising a laminated glass of claim 15.
